(19) United States
(12) Patent Application Publication
(10) Pub. No.: US 2004/0078589 A1
(43) Pub. Date: Apr. 22, 2004

(54) Method for making secure execution of a programme in a micorprocessor-based electronic module

(76) Inventor: Nicolas Giraud, Le Chesnay (FR)

Correspondence Address: LEONARD W. POJUNAS, SCHLUMBERGERSEMA, INC., 30000 MILL CREEK AVENUE, SUITE 100, ALPHARETTA, GA, 30022, US

(21) Appl. No.: 10/451,520

(22) PCT Filed: Dec. 20, 2001
(86) PCT No.: PCT/FR01/04123

(30) Foreign Application Priority Data
Dec. 21, 2000 (FR) 00/16724

(51) Int. Cl. G06F 12/14

(52) U.S. Cl. 713/200

(57) ABSTRACT

The invention concerns a method for making secure execution of a ROM-implanted programme (PROG) in a microprocessor-based electronic module comprising the following steps:

intermittently triggering in an automatic reset timer included in the module, an interruption (IT1, IT2) in the execution of the programme (PROG);

rerouting (60, 66) at each interruption (IT1, IT2), the execution of the programme to an interruption management routine (RITT) comprising, as first instruction, the instruction to return the interruption (IRET) (70) to the programme (62, 66) at the rerouting point of the interruption (IT1, IT2).

The invention also concerns a microprocessor-based electronic module adapted to implement said method.

This invention concerns the secure protection of electronic modules incorporating at least a microprocessor, a ROM/EEPROM type memory containing at least one executable programme, and input/output devices for communication with the exterior. This type of module generally takes the form of a monolithic integrated electronic microcircuit or chip, which once physically protected by any known means can be incorporated in a portable object such as a smart card, microcircuit card or analog card, which can be used in various domains, including in particular bank and other credit cards, mobile radio telephony, pay TV, health care and transport.

In general terms, protection is designed to increase the anti-fraud security of a programme incorporating a certain number of instructions which are particularly critical for correct execution of this programme, in particular certain instructions of an operational nature relating to execution of a transaction by means of the electronic module and/or inherently security-related instructions concerning, for example, authentication of the user, authentication of the transaction and its validity, protection of data confidentiality or data encryption/decryption.

While the fraudulent use of smart cards is not a new phenomenon, the increase in volume and value of transactions conducted by means of smart cards has led swindlers to employ increasingly sophisticated methods and resources. In particular, brief attacks by radiation targeted on the smart card, cause modification of the data and/or the codes transiting via a ROM and/or EEPROM programme memory to the microprocessor on the internal bus, leading to non-execution or irregular execution of certain parts of the code, for example execution of inoperative instructions in place of a secure processing sequence.

Countermeasures based on radiation detectors prove ineffective, due to the fineness and accuracy of the radiation emitters used by swindlers on the one hand, and the risk of radiation-induced perturbation of the processing logic sequence of the sensor on the other. Among other proposed solutions, in particular in the context of French patent application No. 99.08409 in the name of the present applicant, certain solution such as bus parity checks, require modifications to the design and conception of the chip itself, while others, such as the introduction of RAM flags, are in fact purely logic solutions and can consequently be circumvented by the very type of attack which they are designed to neutralise.

The aim of this invention is to ensure correct execution of the instruction code contained in the ROM and/or EEPROM, and that no radiation attack is in process, and in the event of an attack, to stop normally scheduled execution of the programme (execution of the current session).

For this purpose, the invention proposes a method for secure execution of a programme loaded in the ROM and/or EEPROM in a microprocessor-based electronic module, characterised by the fact that it involves at least the following steps:

interruption of execution of the programme is triggered intermittently, using hardware devices incorporated in the module; and

on each interruption, execution of the programme is rerouted, by means of the microprocessor, to an interruption management routine incorporating, as first instruction or one of the first instructions of the routine, an instruction for return to the programme rerouting point.

On each induced interruption, the programme code is rerouted to a routine for processing this interruption which provides for normal return to the programme rerouting point, said programme then continuing its execution. Furthermore, a radiation attack is not capable of preventing initiation of an interruption by the hardware devices incorporated in the module. If this radiation attack persists on execution of the induced interruption processing routine, this leads to non-execution of the programme return instruction, also preventing correct execution of the remainder of this programme. Thus, the method according to the invention provides protection against modification of instructions to be executed by access to hardware devices, and prevents return to the programme in the event of a persistent attack.

The method according to the invention thus provides effective protection against radiation attacks, which can be implemented by using pre-existing circuits (no hardware adaptation or modification of the design or conception of the electronic chip) and limited memory resources, and which does not penalise the performance of the electronic module to any marked degree.

Preferably, the first instruction in the interruption management routine is the instruction for return to the programme rerouting point, to return to the interrupted process. It is not generally necessary to provide for logic processing prior to the return instruction, as this is not executed if a radiation attack is in process. Thus, the interruption management routine can be reduced to a single instruction so as to avoid any marked impact on the performance of the programme, and to avoid excessive use of storage space in the ROM/EEPROM.

According to a preferred practical application of the invention, the interruption management routine is implanted in the ROM and/or EEPROM in the last programme memory position, or just ahead of a shared domain boundary, so as to exit from the authorised programme memory zone on incrementation of the programme counter in the event of non-execution of the programme return instruction. This results in a non-maskable interruption, and instantaneous blocking of the microprocessor, which is immediately perceptible to the user.

According to another interesting variant of the method according to the invention, the interruption management routine programme return instruction is followed immediately in the ROM and/or EEPROM by a fraud indicator positioning sequence stored in the EEPROM or analog memory in particular, to warn the user of a previous fraudulent attack.

According to a preferred practical application of the invention, the hardware devices include an automatic reset timer circuit or analog electronic circuit. An exception is thus raised each time the timer circuit reaches its expiration point. This exception is followed by rerouting of the programme code to the timer interruption processing routine. The choice of an automatic reset timer to generate interruptions is particularly interesting for a number of reasons. Firstly, automatic reset timers form part of the basic equipment of microprocessor-based electronic modules, including microcontrollers in particular, and on the other, because they are relatively easy to implement from the programming point of view. The interruption return instruction is indeed used directly. In conclusion, the automatic reset timer is a very simple and highly reliable hardware device for inducing an interruption without programme intervention and at regular intervals by means of the automatic reset function.

According to a first operational variant, the initialisation value of the timer circuit is made variable, in particular on each programme restart (new session). Advantageously, variation in the initialisation value of the timer circuit involves at least one parameter obtained from a pseudo-random number generator, a sub-assembly also frequently incorporated in microcontrollers for secure functions. Thus, the moment when a process is interrupted and the check executed is made variable and extremely difficult to predict, or even totally unpredictable, for swindlers.

As an option, the invention provides for a number of additional procedures and/or characteristics, designed to further enhance the efficiency of the invention. These include:

repetition of certain instructions in the programme instruction sequence, in particular security-related instructions, to increase the chances of interruption during execution of this sequence of instructions in the event of an attack;

incorporation in the programme instruction sequence of at least one instruction execution time shift loop with, as an option, variation of the time shift from one loop to another, and introduction of a random parameter in this variation by means of a pseudo-random number generator.

The invention also concerns secure electronic modules, each incorporating at least a microprocessor, a ROM and/or EEPROM containing at least one executable programme, the module being characterised in that it incorporates appropriate hardware devices for initiating, intermittently, an interruption in execution of the programme, and in that the ROM and/or EEPROM contains an interruption management routine, including as first instruction or one of the first instructions of the routine, an instruction for return to the programme rerouting point.

According to another optional variant of the module according to the invention, the interruption management routine is loaded in the ROM and/or EEPROM at the last position in programme memory, or just ahead of a shared domain boundary, so as to exit from the authorised programme memory zone on incrementation of the programme counter in the event of non-execution of the programme return instruction.

According to an optional variant of the module according to the invention, the programme return instruction of the interruption management routine is followed immediately in the ROM and/or EEPROM by at least one positioning sequence for a fraud indicator in memory, in particular the EEPROM or analog memory, the indicator being adapted optionally to give warning of a previous fraudulent attack.

According to a preferred practical application of the module according to the invention, the hardware devices include an automatic reset timer circuit or analog electronic circuit.

The module also includes hardware and/or software devices to vary the initialisation value of the timer circuits, in particular using a pseudo-random number generator.

Advantageously, certain instructions, in particular security-related instructions, are repeated in the ROM/EEPROM in the sequence of programme instructions implanted in the module according to the invention.

Also advantageously, at least one time shift loop for execution of certain instructions is loaded in the ROM and/or EEPROM of the module in the programme instruction sequence. As a variant, the time shift is variable from one loop to another, in particular using a pseudo-random number generator.

The invention also concerns a microcircuit card incorporating a secure electronic module as defined above in its various variants.

Other purposes, advantages and characteristics of the invention will emerge from the following description of implementation of the method according to the invention, and a practical application of a microprocessor-based electronic module according to the invention, given as a non-limitative example and referring to the attached diagrams where:

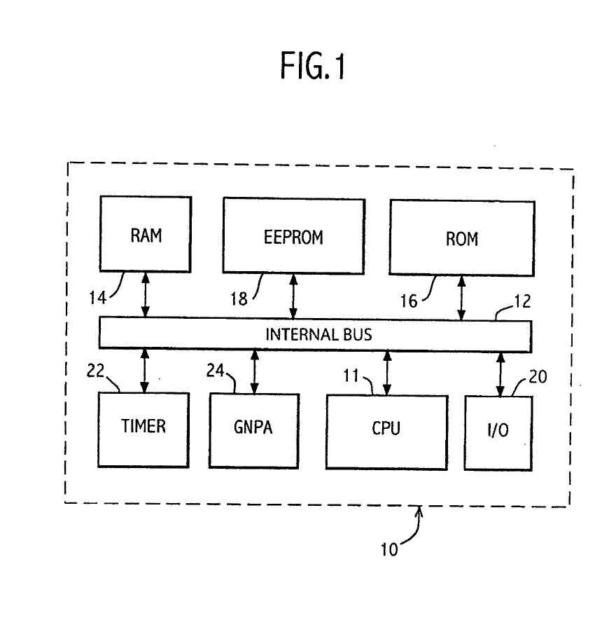

FIG. 1 shows a schematic representation of a practical application for a microprocessor-based electronic module according to the invention; and

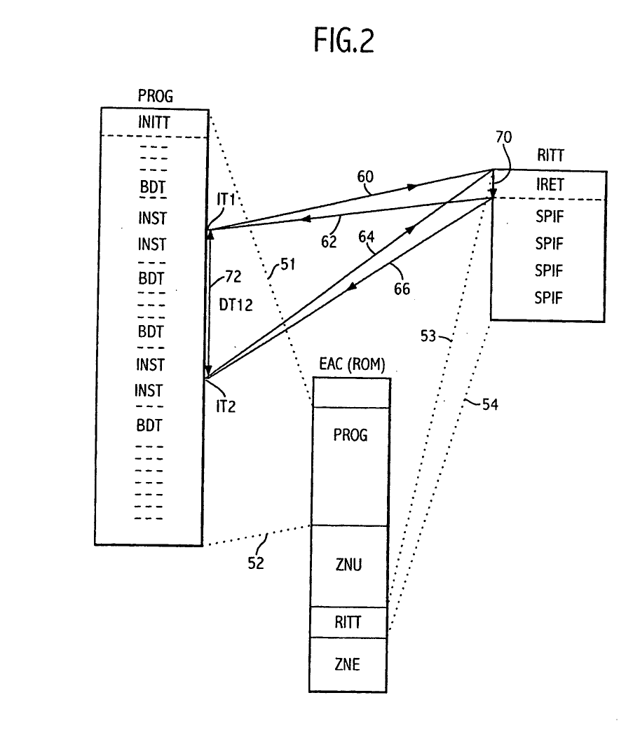

FIG. 2 shows a schematic representation of a code addressing space of the ROM shown in FIG. 1, accompanied by two, more detailed sub-segments of the programme, the code portion to be protected and the interruption routine.

The microprocessor-based monolithic electronic module 10 according to the invention shown in FIG. 1, and described as a non-limitative example, generally incorporates a CPU microprocessor 11, connected bidirectionally by an internal bus 12 to a RAM 14, a ROM 16, EEPROM 18 and an I/O interface 20. Module 10 also incorporates an automatic reset timer 22 and a PRNG pseudo-random number generator (GNPA) 24 connected to the internal bus 12.

As indicated below, timer 22 and generator 24 are used in the context of this invention, to intermittently trigger interruptions in execution of certain programmes loaded in ROM 16, in particular programme the PROG containing security-related instructions, such as encryption/decryption, operator authentication or transaction validation instructions (identified by code INST in FIG. 2) in particular.

As a non-limitative example, a module according to the invention can be used, in association with a base object, to form a microcircuit card, such as a bank card or electronic purse. As regards the rate of timer 22, this is reduced in relation to the clock frequency by a division factor which varies according to module, and is generally between 4 and 32, giving a minimum interval between initiation of two successive interruptions of between 1 and 8 instructions.

FIG. 2 illustrates the code addressing space of ROM 16 in FIG. 1, designated EAC(ROM). Said space EAC(ROM) takes the form of a sequence of code lines (including data and constants) from the lowest address at the top of the column, to the highest address at the bottom. Said space EAC(ROM) is sub-divided into domains containing in particular programmes such as the programme PROG, and routines such as the RITT routine, the interruption management routine triggered by the timer. Space EAC(ROM) also includes a non-executable memory zone ZNE and a non-utilized executable memory zone ZNU, at the bottom of the column. According to an extremely interesting optional characteristic of the invention described below, routine RITT is loaded just ahead of zone ZNE.

FIG. 2 also contains in an enlarged column illustrations of the programme PROG and of the interruption management routine RITT, with the correspondence segments of the head and tail addresses of the corresponding software sub-sections, segments 51 and 52 for the PROG column and segments 53 and 54 for the RITT column, shown in dotted lines.

The head of programme PROG includes instruction set INITT for configuration and initialisation of the automatic reset timer 22, including management of utilisation of generator 24 for determination of the initialisation value of the decremental counter integrated in timer 22. Instruction set INITT is followed by the lines of programme PROG proper (each undifferentiated line is represented by 3 dashes in the centre of the line). As represented in FIG. 2 as an example, programme PROG includes at least two instructions INST to be secured. These instructions can be identical (repetition to ensure that the instruction has a good chance of being executed with a control interruption) or different if there is a multiplicity of instructions (operator authentication at start of transaction, and transaction validation at the end). Instructions INST are bracketed by time shift loops BDT, designed to shift execution of the next instruction INST by a random time interval.

Routine RITT, the timer interruption processing routine, includes as its first instruction, instruction IRET for interruption return to the rerouting point of programme PROG. As an option, instruction IRET is followed by one or more sequences for positioning fraud indicator SPIF in memory, in this case EEPROM 18. A procedure for preventing subsequent operation of the electronic module is associated with positioning a fraud indicator proper.

Execution of programme PROG is as follows, running the PROG column instruction sequence, and commences by loading the initial value in timer 22, this value being pre-established and, where appropriate, already modified by integration of a variation parameter obtained from generator GNPA 24. As programme PROG is executed, the instantaneous value of the up/down counter integrated in timer 22 decreases to expiration, reaching zero during execution of a PROG instruction, for example first instruction INST in the PROG column. This is followed by raising of an exception, and after complete execution of the current instruction, rerouting to point IT1 following arrow 60 from the programme code to the timer interruption processing routine represented by the RITT column, the next instruction to be executed in the “programme counter” buffer of microprocessor 11 being the first instruction in the RITT column, namely instruction IRET for interruption return to point IT1 following arrow 62. In the absence of any radiation attack, instruction IRET is executed normally following arrow 70, in the same way as return to point IT1 following arrow 62. The up/down counter of the timer is then reinitialised automatically, corresponding to execution time interval DT12 for programme PROG between point IT1 (“return” instant) and point IT2 corresponding to the second interruption (“rerouting” instant), and represented in the PROG column by double arrow 72. In the absence of any radiation attack on second interruption IT2, the procedure described above is repeated, with rerouting to routine RITT following arrow 64, normal execution following arrow 70 of instruction IRET of this routine, and return to point IT2 following arrow 66.

As a variant, it is possible to use a software-based non-automatic reset up/down counter integrated in routine RITT. It is thus possible to give the up/down counter a new initial value different from the preceding initial value, where appropriate, by adding a random component with generator GNPA 24. This characteristic presents a particular advantage where it is desired to increase or decrease interruption frequency according to the state of progress with execution of the programme.

Generally, a radiation attack lasts approximately the execution time for a number of programme code instructions, whether these are executed normally or in an inoperative manner due to alteration of the programme codes transiting on internal bus 12 at the time of a radiation attack. Thus, the variable intervals between two interruptions are separated by about one hundred instructions, bearing in mind that reduction of the length of intervals between interruptions is always possible during execution of a code programme round the instructions to be secured (subject to possibilities for triggering the timer used), by taking care not to increase execution time for the programme concerned to any great extent.

If a radiation attack is in process at the moment when the value of the up/down counter of timer 22 reaches zero, the timer interruption procedure fully managed by a hardware device insensitive to this type of attack (microprocessor 11) is executed normally, with rerouting to routine RITT following arrow 60. On the other hand, a radiation attack prevents execution of the interruption return software instruction IRET following arrow 70 to rerouting point IT1, and execution of programme PROG cannot be restarted, the programme counter of microprocessor 11 keeping the first instruction SPIF as the next instruction. Inoperative run of routine RITT continues up to the last SPIF instruction, noting that if the attack terminates before the last SPIF instruction, at least one fraud indicator positioning sequence is executed according to instruction SPIF, to announce the previous radiation attack to the microprocessor operating system (OS) and inducing OS barring of current session continuation.

Due to the special position of routine RITT in ROM 16, in the last programme memory location (or just ahead of a shared domain boundary), incrementation of the programme counter at the end of routine RITT causes exit from the authorised programme memory zone and entry in the non-executable memory zone ZNE. This has the effect of initiating a non-maskable interruption, and a processing to bar continuation of the current session.

To conclude, it will be noted that implementation of the method according to the invention is both extremely simple and undemanding in terms of resources and time. It uses the automatic reset timer incorporated in the chip and the associated interruption. The only additions required are an initialisation code at start of programme session, and the interruption management routine, it being possible to reduce this routine to a single instruction. The execution time consumed by implementation of the method corresponds to initialisation of the timer at start of session, and execution of the interruption return instruction on each interruption. The method according to the invention can be used for the most sensitive portions of a programme, or can be extended to protection of the complete programme code with no real adverse effect on the performance of the code, either in terms of memory space or execution time.

Module 10, with its secure programme according to the invention as presented above, is mounted on an appropriate base to constitute, for example, a microcircuit card which can be used in various domains including bank and other credit cards, mobile radiotelephony, pay TV, health care and transport in particular.

The invention is not restricted to the utilisation of electronic modules incorporating automatic reset timers, but applies also to electronic modules, the architecture and hardware devices of which can trigger induced interruptions, and in particular electronic modules incorporating time base circuits similar to automatic reset or software reset timer circuits, for example circuits based either on up/down counting of clock pulses, or counting of the number of instructions or instruction lines effectively executed.

1. Method for secure execution of a programme implanted in ROM (16) and/or EEPROM (18) in a microprocessor (11) based electronic module (10) characterised by its method of protection against radiation attack, or any other attack resulting in the modification of the executable instructions, and non-execution or incorrect execution of certain parts of the code, involving at least the following steps:
interruption of execution of the programme is triggered intermittently using hardware devices (11) incorporated in module (10); and
execution of the programme is rerouted, by means of the microprocessor, on each interruption, to an interruption management routine incorporating, as its first instruction or one of the first instructions of the routine, an instruction for return to the programme rerouting point.

2. Method according to claim 1 characterised in that the interruption management routine is loaded in ROM (16) and/or EEPROM (18), in the last programme memory location or immediately before the shared domain boundary, so as to exit from the authorised programme memory zone when the programme counter is incremented following non-execution of the programme return instruction.

3. Method according to claim 1, characterised in that the interruption management routine programme return instruction is followed immediately in ROM (16) and/or EEPROM (18) by a positioning sequence for a fraud indicator in memory, in particular in EEPROM (18) or analog memory, to give warning of a previous fraudulent attack.

4. Method according to claim 1, characterised in that said hardware devices include automatic reset timer circuit (22) or a similar electronic circuit.

5. Method according to claim 4, characterised in that the initialisation value of timer circuit (22) is variable.

6. Method according to claim 5, characterised in that variation of the initialisation value for timer circuit (22) includes at least one parameter obtained from pseudo-random number generator (24).

7. Method according to claim 1, characterised in that certain instructions, including security-related instructions in particular, are repeated in the programme instruction sequence.

8. Method according to claim 1, characterised in that at least one instruction execution time shift loop is introduced in the programme instruction sequence.

9. Method according to claim 8, characterised in that the time shift is variable from one loop to another.

10. Method according to claim 9, characterised in that variation of the time shift includes at least one parameter obtained from pseudo-random number generator (24).

11. Electronic module (10) incorporating at least a microprocessor (11) and a ROM (16) and/or EEPROM (18), and containing at least one executable programme, the module being characterised in that it incorporates, for the purpose of protecting against radiation attacks or any other form of attack resulting in modification of executable instructions, and non-execution or defective execution of certain parts of the code, hardware devices (22) designed to trigger, intermittently, an interruption in execution of the programme, and in that said ROM (16) and/or EEPROM (18) contains an interruption management routine having as its first instruction, or one of the first instructions of the routine, the instruction for return to the programme rerouting point.

12. Module (10) according to claim 11, characterised in that said hardware devices include automatic reset type timer circuit (22) or a similar electronic circuit.

13. Module (10) according to claim 14, characterised in that it incorporates hardware and/or software devices to vary the initialisation value of the timer circuit, in particular using a pseudo-random number generator (24).

14. Microcircuit card characterised in that it incorporates an electronic module according to claim 11.
